(19) United States
(12) Patent Application Publication
(10) Pub. No.: US 2019/0126905 A1
(43) Pub. Date: May 2, 2019

(54) VEHICLE CONTROL SYSTEM, VEHICLE CONTROL METHOD, AND COMPUTER READABLE STORAGE MEDIUM

(71) Applicant: HONDA MOTOR CO., LTD., Tokyo (JP)

(72) Inventor: Takahito Fujita, Wako-shi (JP)

(21) Appl. No.: 16/155,978

(22) Filed: Oct. 10, 2018

(30) Foreign Application Priority Data
Oct. 30, 2017 (JP) 2017-208961

(51) Int. Cl. B60W 20/12; B60K 6/46; B60W 10/06; B60W 10/08

(52) U.S. Cl. CPC B60W 20/12; B60K 6/46; B60W 10/06; B60W 2710/08; B60W 2540/30; B60Y 2200/92; B60W 2710/06; B60W 10/08

(57) ABSTRACT

A vehicle control system, a vehicle control method, and a computer readable storage medium capable of controlling a charging ratio in accordance with a user's characteristics are provided. A vehicle control system includes: a power generator including an internal combustion engine is configured to output power and a power generator is configured to generate electric power using the power output by the internal combustion engine; an information acquirer is configured to acquire identification information for identifying a user; and a controller is configured to adjust a period in which the power generator is operated or an electric power per unit time generated by the power generator in accordance with the identification information acquired by the information acquirer.

### CROSS-REFERENCE TO RELATED APPLICATION

Priority is claimed on Japanese Patent Application No. 2017-208961, filed on Oct. 30, 2017, the content of which is incorporated herein by reference.

### BACKGROUND OF THE INVENTION

### Field of the Invention

The present invention relates to a vehicle control system, a vehicle control method, and a computer readable storage medium.

### Description of Related Art

Hybrid vehicles in which a storage battery and a driving mechanism (for example, an internal combustion engine and an electric motor) are mounted are widely used. For the purpose of using up fuel before the fuel deteriorates, a control device of a hybrid vehicle estimates timing at which a user refuels has been disclosed (for example, Japanese Unexamined Patent Application, First Publication No. 2012-166777). However, in the control device described above, control of a charging ratio according to a user's characteristics is not taken into account.

An aspect of the present invention is in consideration of such situations, and one object thereof is to provide a vehicle control system, a vehicle control method, and a computer-readable storage medium capable of controlling a charging ratio in accordance with a user's characteristics.

### SUMMARY OF THE INVENTION

A vehicle control system, a vehicle control method, and a computer readable storage medium according to the present invention employ the following configurations.

(1): According to one aspect of the present invention, a vehicle control system includes: a power generator including an internal combustion engine is configured to output power and a power generator is configured to generate electric power using the power output by the internal combustion engine; an information acquirer is configured to acquire identification information for identifying a user; and a controller is configured to adjust a period in which the power generator is operated or an electric power per unit time generated by the power generator in accordance with the identification information acquired by the information acquirer.

(2): In the aspect (1) described above, a specifier is configured to specify an index of the user by referring to relating information associating the index with the identification information using the identification information of the user acquired by the information acquirer is further included, and the controller is configured to adjust the period in which the power generator is operated or the electric power per unit time generated by the power generator on the basis of the index specified by the specifier.

(3): In the aspect (2) described above, in a case in which a first index specified by the specifier is specified among a plurality of indexes including at least the first index and a second index representing a lower sensitivity than that of the first index, the controller is configured to perform at least one or more control operations among controlling the period in which the power generator is operated such that it becomes longer, controls the electric power per unit time generated by the power generator to be higher, controls a timing at which the power generator is operated to be earlier, and controls a timing at which the power generator is stopped after is configured to operate the power generator to be later than in a case in which the second index is specified.

(4): In any one of the aspects (1) to (3) described above, a storage battery is configured to accumulate electric power generated by the power generator and an electric motor for driving connected to driving wheels of a vehicle and rotate the driving wheels by performing driving using electric power supplied from the power generator or the storage battery are further included, and the power of the internal combustion engine is used only by the generator.

(5): In any one of the aspects (1) to (4) described above, a specifier is configured to specify an index of the user by referring to relating information associating the index with the identification information using the identification information of the user acquired by the information acquirer is further included, and the controller controls the power generator such that generated electric power is not below a lower limit threshold of electric power, which is set for the index specified by the specifier, accumulated in the storage battery is configured to accumulate the electric power generated by the power generator.

(6): In any one of the aspects (1) to (3) described above, a specifier is configured to specify an index relating to the identification information of the user and a distance to a destination acquired by the information acquirer by referring to relating information associating the index and the distance to the destination with the identification information is further included, and the information acquirer is configured to acquire the distance to the destination relating to the acquired identification information.

(7): In any one of the aspects (1) to (6) described above, in the relating information, in a case in which the distance to the destination is long, a higher index is associated with the identification information than in a case in which the distance to the destination is short, and, in a case in which the distance to the destination is long, the specifier is configured to specify a higher index than in a case in which the distance to the destination is short.

(8): According to one aspect of the present invention, a vehicle control system further includes a storage battery is configured to accumulate the electric power generated by the generator, and an electric motor for driving connected to driving wheels of a vehicle and rotating the driving wheels by being driven using electric power supplied from the power generator or the storage battery; wherein the power of the internal combustion engine being used only by the power generator, wherein the controller is configured to change the reference remaining amount in accordance with the identification information acquired by the information acquirer and operate the power generator in a case in which an amount of electric power accumulated in the storage battery is below a reference remaining amount.

(9): According to one aspect of the present invention, there is provided a vehicle control method using an in-vehicle computer. The vehicle control method includes: acquiring identification information for identifying a user; and adjusting a period in which a power generator including an internal combustion engine is configured to output power and a power generator is configured to generate electric power using the power output by the internal combustion engine is operated or an electric power per unit time generated by the power generator in accordance with the acquired identification information.

(10): According to one aspect of the present invention, there is provided a non-transitory computer-readable storage medium that stores a computer program to be executed by a computer to perform at least: acquire identification information for identifying a user; and adjust a period in which a power generator including an internal combustion engine is configured to output power and a power generator is configured to generate an electric power using the power output by the internal combustion engine is operated or an electric power per unit time generated by the power generator in accordance with the acquired identification information.

According to the aspects (1) to (10), the charge ratio can be controlled in accordance with a user's characteristics.

According to the aspect (2), the electric power to be generated is adjusted, for example, on the basis of an index of a user such as a degree of user's anxiety about a decrease in the charge ratio and a degree of user's sense of security for a sufficient charge ratio, in other words, an index representing a sensitivity for the charge ratio, and accordingly, the user's anxiety can be relieved, or the degree of satisfaction of the user can be improved.

### BRIEF DESCRIPTION OF THE DRAWINGS

FIG. 1 is a diagram showing an example of the configuration of a vehicle in which a vehicle system including a vehicle control system is mounted;

FIG. 2 is a diagram showing an example of the functional configuration of a plan controller;

FIG. 3 is a diagram showing an example of sensitivity information;

FIG. 4 is a flowchart showing an example of the flow of a process executed by a plan controller;

FIG. 5 is a diagram showing an example of a power generation plan;

FIG. 6 is a diagram showing another example (1) of a power generation plan;

FIG. 7 is a diagram showing another example (2) of a power generation plan;

FIG. 8 is a diagram showing a functional configuration of a learning device;

FIG. 9 is a diagram showing an example of user information;

FIG. 10 is a flowchart showing the flow of a process executed by a learning device;

FIG. 11 is a diagram showing an example of sensitivity information used in a second embodiment;

FIG. 12 is a diagram showing an example of user information; and

FIG. 13 is a diagram showing an example of the hardware configuration of a controller (plan controller) according to an embodiment.

### DETAILED DESCRIPTION OF THE INVENTION

Hereinafter, a vehicle control system, a vehicle control method, and a computer-readable storage medium according to embodiments of the present invention will be described with reference to the drawings.

### First Embodiment

### [Entire Configuration]

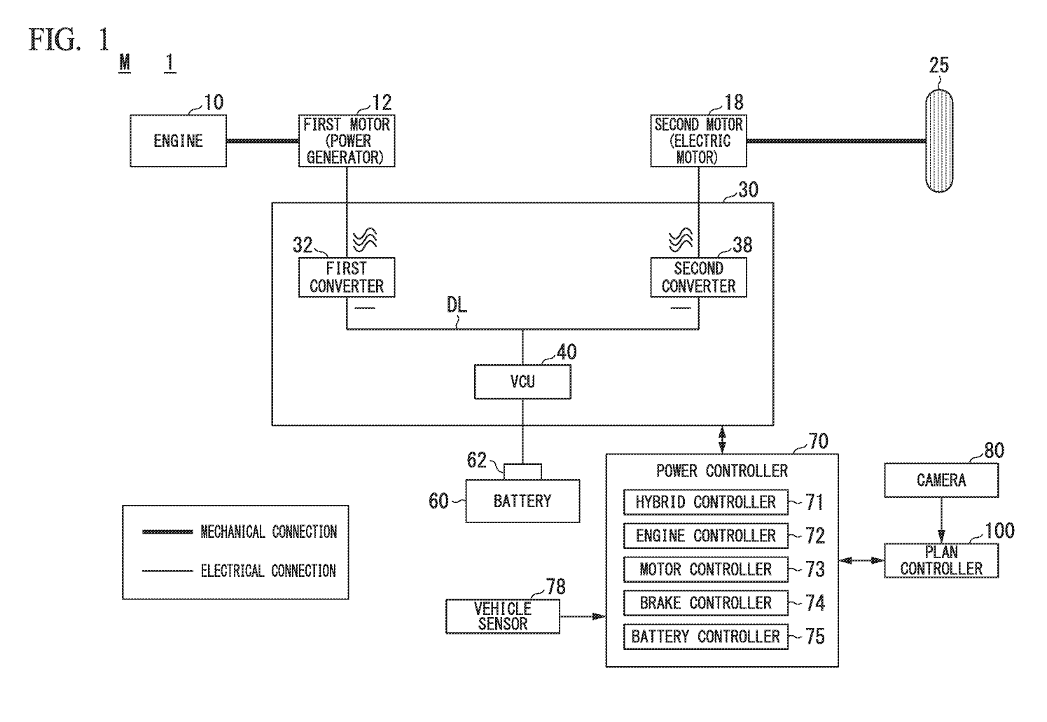

FIG. 1 is a diagram showing an example of the configuration of a vehicle in which a vehicle system 1 including a vehicle control system is mounted (hereinafter, referred to as a subject vehicle M). A vehicle in which the vehicle system 1 is mounted is, for example, a vehicle having two wheels, three wheels, four wheels, or the like, and a driving source thereof is an internal combustion engine such as a diesel engine or a gasoline engine, an electric motor, or a combination thereof. In a case in which an electric motor is included, the electric motor operates using electric power generated using a power generator connected to an internal combustion engine or discharge electric power of a secondary cell or a fuel cell. In the following description, a hybrid vehicle employing a series system will be described as an example. The series system is a system in which an engine and driving wheels are not mechanically connected, the power of the engine is used only for power generation using a power generator, and generated electric power is supplied to an electric motor for driving. The vehicle may be a vehicle in which a battery can be charged in a plug-in manner.

As shown in FIG. 1, in the vehicle, for example, an engine 10, a first motor (power generator) 12, a second motor (electric motor) 18, driving wheels 25, a power control unit (PCU) 30, a battery 60, a power controller 70, a vehicle sensor 78, a camera 80, and a plan controller 100 are mounted.

The engine 10 is an internal combustion engine that outputs power by combusting fuel such as gasoline. The engine 10, for example, is a reciprocating engine including a cylinder and a piston, an intake valve, an exhaust valve, a fuel injector, an injection plug, a connecting rod, a crank shaft, and the like. The engine 10 may be a rotary engine. The power that is outputable by the engine 10 is a power that is less than the power required for the first motor 12 to generate an amount of electric power used for driving the second motor 18 in real time (or an amount of electric power allowing the subject vehicle M to run at a predetermined speed or more). The engine has a small size and is lightweight and thus has an advantage of having a high degree of freedom in an in-vehicle layout.

The first motor 12, for example, is a three-phase AC generator. The first motor 12 has a rotor connected to an output shaft (for example, a crank shaft) of the engine 10 and generates electric power using power output by the engine 10. Hereinafter, a combination of the engine 10 and the first motor 12 may be referred to as a “power generator”.

The second motor 18, for example, is a three-phase AC motor. A rotor of the second motor 18 is connected to the driving wheels 25. The second motor 18 outputs power to the driving wheels 25 using supplied electric power. The second motor 18 generates electric power using kinetic energy of the vehicle when the vehicle decelerates. Hereinafter, a power generating operation using the second motor 18 may be referred to as regeneration.

The PCU 30, for example, includes a first converter 32, a second converter 38, and a voltage control unit (VCU) 40. The configuration in which such constituent elements are grouped as the PCU 30 is merely one example, and such constituent elements may be disposed in a distributed manner.

The first converter 32 and the second converter 38, for example, are AC-to-DC converters. DC-side terminals of the first converter 32 and the second converter 38 are connected to a DC link DL. A battery 60 is connected to the DC link DL through a VCU 40. The first converter 32 converts AC generated by the first motor 12 into a DC and outputs the DC to the DC link DL or converts a DC supplied through the DC link DL into an AC and supplies the AC to the first motor 12. Similarly, the second converter 38 converts AC generated by the second motor 18 into a DC and outputs the DC to the DC link DL or converts a DC supplied through the DC link DL into an AC and supplies the AC to the second motor 18.

The VCU 40, for example, is a DC-to-DC converter. The VCU 40 boosts electric power supplied from the battery 60 and outputs the boosted electric power to the DC link DL.

The battery 60, for example, is a secondary battery such as a lithium ion battery.

The power controller 70, for example, includes a hybrid controller 71, an engine controller 72, a motor controller 73, a brake controller 74, and a battery controller 75. The hybrid controller 71 outputs an instruction to the engine controller 72, the motor controller 73, the brake controller 74, and the battery controller 75. An instruction using the hybrid controller 71 will be described later.

The engine controller 72 performs ignition control, throttle opening degree control, fuel injection control, fuel cutting control, and the like of the engine 10 in accordance with an instruction from the hybrid controller 71. The engine controller 72 may calculate an engine speed on the basis of an output of a crank angle sensor mounted in the crank shaft and output the engine speed to the hybrid controller 71.

The motor controller 73 performs switching control of the first converter 32 and/or the second converter 38 in accordance with an instruction from the hybrid controller 71.

The brake controller 74 controls a brake device not shown in the drawing in accordance with an instruction from the hybrid controller 71. The brake device is a device that outputs a brake torque corresponding to a driver's braking operation to each vehicle wheel.

The battery controller 75 calculates the amount of electric power (for example, a state of charge (SOC); charging ratio) of the battery 60 on the basis of an output of a battery sensor 62 mounted in the battery 60 and outputs the amount of electric power to the hybrid controller 71.

The vehicle sensor 78, for example includes an acceleration opening degree sensor, a vehicle speed sensor, a brake depression amount sensor, and the like. The acceleration opening degree sensor is mounted in an acceleration pedal, detects an amount of operation on the acceleration pedal, and outputs a degree of acceleration opening derived on the basis of a result of the detection to the power controller 70. The acceleration pedal is one example of an operator that accepts an acceleration instruction from a driver. The vehicle sensor, for example, includes a vehicle wheel speed sensor mounted in each vehicle wheel and a speed calculator, derives a speed of the vehicle (vehicle speed) by integrating vehicle wheel speeds detected by vehicle wheel speed sensors, and outputs the derived result to the power controller 70. The brake depression amount sensor is mounted in a brake pedal, detects an amount of operation on the brake pedal, and outputs an amount of brake depression derived on the basis of the detection result to the power controller 70. The brake pedal is one example of an operator that accepts a deceleration or stop instruction from a driver.

Here, control using the hybrid controller 71 will be described. The hybrid controller 71, first, derives a driving shaft required torque Td on the basis of the degree of acceleration opening and a target vehicle speed and determines a driving shaft required power Pd output by the second motor 18 on the basis of the derived result. The hybrid controller 71 determines whether to operate the engine 10 or not on the basis of the determined driving shaft required power Pd, power consumption of an auxiliary machine, the amount of electric power of the battery 60, and the like. Then, in a case in which the engine 10 is determined to be operated, the hybrid controller 71 determines an engine power Pe to be output by the engine 10.

The hybrid controller 71 determines the reaction torque of the first motor 12 in accordance with the determined engine power Pe such that it balances with the engine power Pe. The hybrid controller 71 outputs determined information to the engine controller 72. In a case in which the brake is operated by a driver, the hybrid controller 71 determines a distribution between a brake torque that can be output through regeneration of the second motor 18 and a brake torque to be output by the brake device and outputs a result of the determination to the motor controller 73 and the brake controller 74.

The camera 80, for example, is a digital camera using a solid state imaging device such as a charge coupled device (CCD) or a complementary metal oxide semiconductor (CMOS). One or a plurality of cameras 80 are mounted at arbitrary points in the vehicle in which the vehicle system 1 is mounted. For example, the camera 80 is mounted at a position at which a user (for example, a driver or a vehicle occupant) of the vehicle can be imaged. The camera 80, for example, images an area of an imaging target at predetermined intervals and outputs a captured image to the plan controller 100. The camera 80 may be a stereo camera.

The vehicle system 1 may include a communication unit not shown in the drawing. The communication unit, for example, communicates with other vehicles present in the vicinity of the subject vehicle M using a cellular network, a Wi-Fi network, Bluetooth (registered trademark), a dedicated short range communication (DSRC), or the like or communicates with various server apparatuses through a radio base station.

The vehicle system 1 further includes a microphone, a fuel system, a temperature sensor, a navigation device, and the like not shown in the drawing in addition to the configuration described above. The navigation device, for example, includes a global navigation satellite system (GNSS) receiver, a navigation HMI, and a route determiner and stores map information in a storage device such as a hard disk drive (HDD) or a flash memory. The GNSS receiver identifies a position of the subject vehicle M on the basis of signals received from GNSS satellites. The navigation HMI includes a display device, a speaker, a touch panel, a key, and the like. The route determiner, for example, determines a route (hereinafter, referred to as a route on the map) from a position of the subject vehicle M identified by the GNSS receiver (or an input arbitrary position) to a destination input by a user using the navigation HMI by referring to first map information. The map information, for example, is information that represents road shapes using links representing roads and nodes connected using links. The navigation device, for example, may be implemented by a function of a terminal device such as a smartphone or a tablet terminal held by a user.

### [Plan Controller]

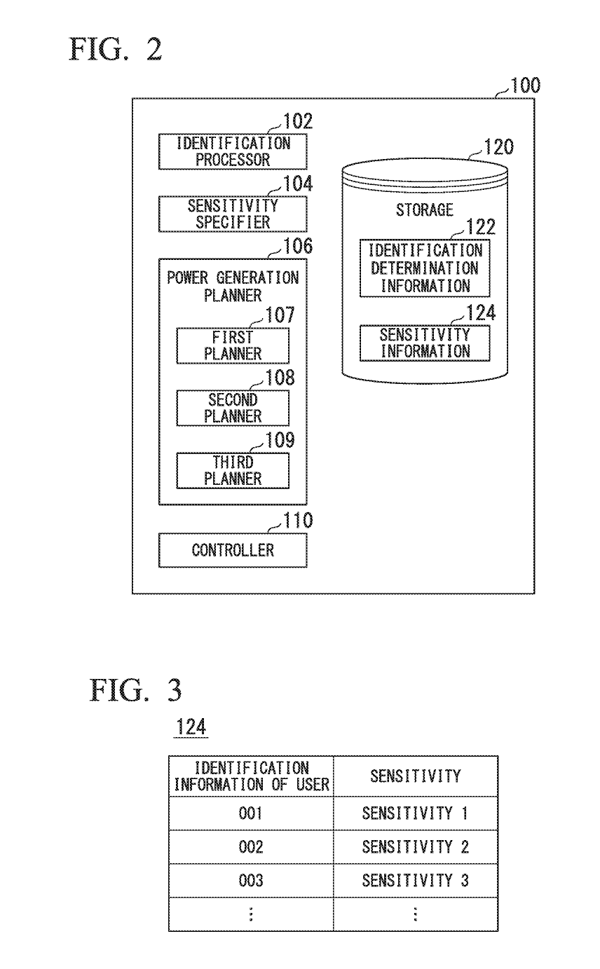

FIG. 2 is a diagram showing an example of the functional configuration of the plan controller 100. The plan controller 100, for example, includes an identification processor 102, a sensitivity specifier 104, a power generation planner 106, a controller 110, and a storage 120. The identification processor 102, the sensitivity specifier 104, the power generation planner 106, and the controller 110, for example, are implemented, for example, when a hardware processor such as a central processing unit (CPU) executes a program (software). Some or all of such constituent elements may be implemented by hardware (a circuit unit; including circuitry) such as a large scale integration (LSI), an application specific integrated circuit (ASIC), a field-programmable gate array (FPGA), or a graphics processing unit (GPU) or may be implemented by cooperation between software and hardware. The storage 120, for example, is implemented by a nonvolatile storage device such as a read only memory (ROM), an electrically erasable and programmable read only memory (EEPROM), or a hard disk drive (HDD) and a volatile storage device such as a random access memory (RAM) or a register. A program may be stored in a storage device such as a hard disk drive (HDD) or a flash memory in advance, or a program may be stored in a storage medium such as a DVD or a CD-ROM that can be loaded or unloaded and be installed in a storage device by loading the storage medium in a drive device.

In the storage 120, identification determination information 122 and sensitivity information 124 to be described later are stored.

The identification processor 102, for example, performs an image recognizing process for an image captured by the camera 80. The identification processor 102 compares a result of the image recognizing process and templates included in the identification determination information 122 and extracts a template that is similar to the result of the image recognizing process. The identification processor 102 acquires identification information representing a user associated with the extracted template. In the identification determination information 122, a template including a feature amount extracted by the image recognizing process for an image captured by the user is stored. This template is prepared for each user and is associated with identification information.

The identification processor 102 may specify identification information of a user on the basis of a user's operation instead of (in addition to) the image. For example, the identification processor 102 acquires information output in accordance with an operation (an operation of inputting a number or the like) performed on an operation unit installed in the subject vehicle M and specifies identification information of the user on the basis of the acquired information. In this case, in the identification determination information 122, the identification information of the user is associated with the output information described above.

The sensitivity specifier 104 specifies a sensitivity of the user by referring to the sensitivity information 124. FIG. 3 is a diagram showing an example of the sensitivity information 124. The sensitivity information 124 is information with which an index representing sensitivity for the SOC of the battery 60 is associated. More specifically, in the sensitivity information 124, the height of the sensitivity is associated with the identification information of a user. The height of the sensitivity is a height of anxiety about the SOC (running out of electric power). A user having a high sensitivity has higher anxiety about insufficiency of the SOC than a user having a low sensitivity in a state in which the SOC has a predetermined value (for example, a state in which the charge ratio of the SOC is 60%). For example, a user having a sensitivity 1 has anxiety about insufficiency of the SOC in a case in which the SOC is below a first threshold, a user having a sensitivity 2 has anxiety about insufficiency of the SOC in a case in which the SOC is below a second threshold, and a user having a sensitivity 3 has anxiety about insufficiency of the SOC in a case in which the SOC is below a third threshold (here, the first threshold<the second threshold<the third threshold). In this embodiment, the sensitivity is higher in order of the sensitivity 3, the sensitivity 2, and the sensitivity 1. In a case in which the sensitivity 2 or the sensitivity 3 is a “first index,” the sensitivity 1 is one example of a “second index.”

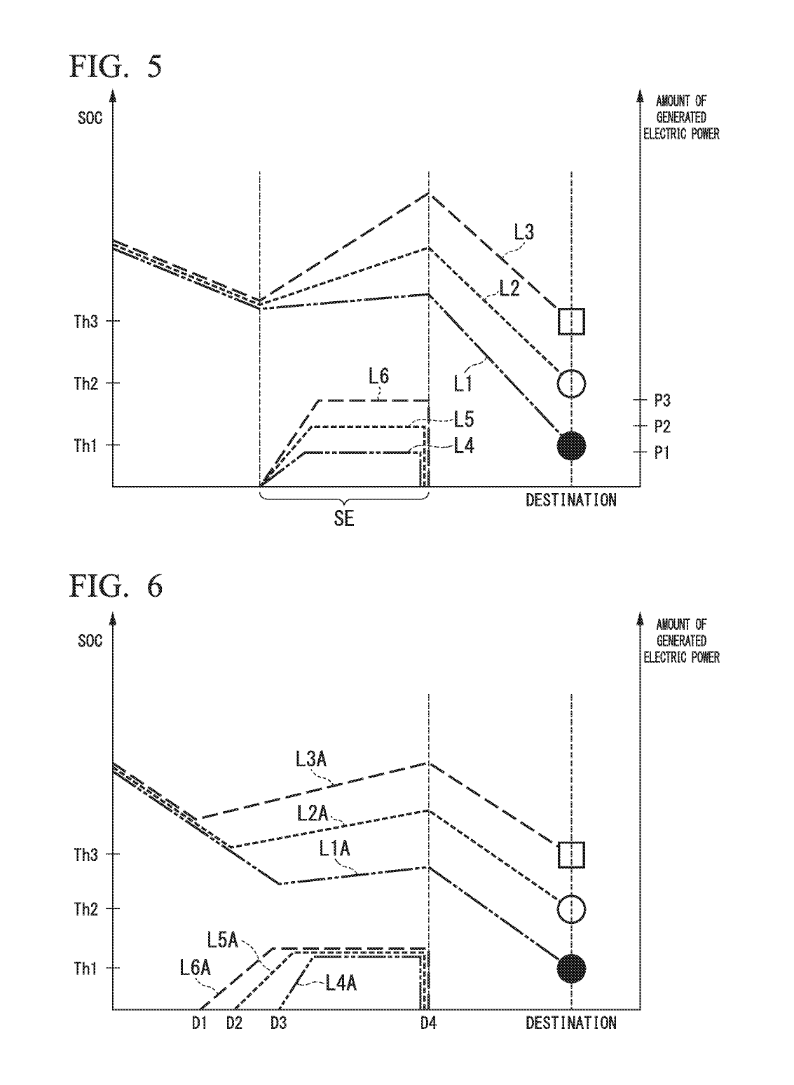

The power generation planner 106, for example, includes a first planner 107, a second planner 108, and a third planner 109. The first planner 107, the second planner 108, and the third planner 109 respectively execute processes in a case in which a sensitivity specified by the sensitivity specifier 104 is the sensitivity 1, the sensitivity 2, and the sensitivity 3. The first planner 107, the second planner 108, and the third planner 109 respectively generates power generation plans (a first power generation plan to a third power generation plan) such that there is no anxiety about insufficiency of the SOC for users having the sensitivity 1, the sensitivity 2, and the sensitivity 3. Here, a power generation plan is a plan in which a timing at which the power generator is operated, an amount of electric power per unit time generated by the power generator, and the like are specified. Details of the first power generation plan to the third power generation plan will be described later (see FIGS. 5 and 6).

The controller 110 operates the power generator in accordance with the power generation plan generated by the power generation planner 106.

### [Flowchart]

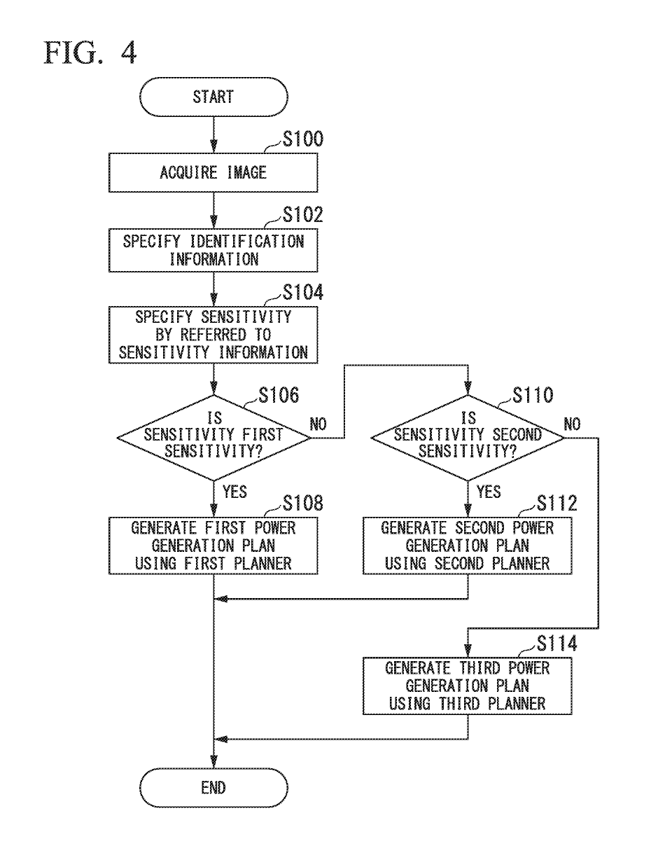

FIG. 4 is a flowchart showing an example of the flow of a process executed by the plan controller 100. This process, for example, is a process executed before the subject vehicle M departs. First, the identification processor 102 acquires an image of a user captured using the camera 80 (Step S100).

Next, the identification processor 102 performs an image recognizing process for the image acquired in Step S100 and specifies identification information of a user using a result of the image recognizing process by referring to the identification determination information 122 (Step S102).

Next, the sensitivity specifier 104 specifies a sensitivity of the specified user by referring to the sensitivity information 124 using the identification information of the user specified in Step S102 (Step S104). Next, the sensitivity specifier 104 determines whether or not the sensitivity specified in Step S104 is the first sensitivity (Step S106). In a case in which the specified sensitivity is the first sensitivity, the first planner 107 generates a first power generation plan (Step S108).

On the other hand, in a case in which the specified sensitivity is not the first sensitivity, the sensitivity specifier 104 determines whether the sensitivity specified in Step S104 is the second sensitivity (Step S110). In a case in which the specified sensitivity is the second sensitivity, the second planner 108 generates a second power generation plan (Step S112). In a case in which the specified sensitivity is not the second sensitivity, the third planner 109 generates a third power generation plan (Step S114). In this way, the process of one routine of this flowchart ends.

### [Details of Power Generation Plan]

The power generation planner 106, for example, generates a plan causing the power generator to generate electric power with priority in a section in which the subject vehicle M is estimated to run at a predetermined speed or more, a section in which a sound of the running environment is a sound having a predetermined magnitude or more, or the like. The power generation planner 106 generates a power generation plan such that the SOC is not below the SOC set for each sensitivity relating to a user until the subject vehicle arrives at a destination.

FIG. 5 is a diagram showing an example of the power generation plan. The vertical axis represents the SOC or the amount of generated electric power generated by the power generator, and the horizontal axis represents a distance from the current position of the subject vehicle M. Transition lines L1 to L3 respectively represent transitions of SOC of the first power generation plan to the third power generation plan (to be described later), and transition lines L4 to L6 respectively represent transitions of the amounts of generated electric power of the first power generation plan to the third power generation plan (to be described later). For example, in a case in which the destination is set as shown in the drawing, the first planner 107 generates a power generation plan such that the SOC is not below the first threshold Th1, the second planner 108 generates a power generation plan such that the SOC is not below the second threshold Th2, and the third planner 109 generates a power generation plan such that the SOC is not below the third threshold Th3.

More specifically, in a case in which electric power is generated in a predetermined section SE, the first planner 107 generates a first power generation plan causing the power generator to generate a first amount of electric power P1, the second planner 108 generates a second power generation plan causing the power generator to generate a second amount of electric power P2, and the third planner 109 generates a third power generation plan causing the power generator to generate a third amount of electric power P3. In order of the first power generation plan<the second power generation plan<the third power generation plan, the electric power per unit time generated by the power generator increases.

As described above, since the power generator performs power generation such that the SOC is not below a threshold relating to the sensitivity of a user, the user's anxiety can be alleviated. In other words, the charge ratio can be controlled in accordance with characteristics of a user.

FIG. 6 is a diagram showing another example (1) of the power generation plan. Description similar to that presented with reference to FIG. 5 will not be presented here. Transition lines L1A to L3A respectively represent transitions of SOC of a first power generation plan to a third power generation plan, and transition lines L4A to L6A respectively represent transitions of the amounts of generated electric power of the first power generation plan to the third power generation plan. More specifically, in a case in which the power generator is stopped at a distance D4, the first planner 107 starts the power generator at a point positioned a distance D3, the second planner 108 starts the power generator at a point positioned a distance D2, and the third planner 109 starts the power generator at a point positioned a distance D1. In order of the distance D1<the distance D2<the distance D3, a distance from a departure point is shorter. In other words, in order of the third plan, the second plan, and the first plan, a time in which the power generator is operated is longer.

As described above, since the power generator generates electric power such that the SOC is not below a threshold relating to the sensitivity of a user, the user's anxiety can be alleviated. In other words, the charge ratio can be controlled in accordance with characteristics of a user.

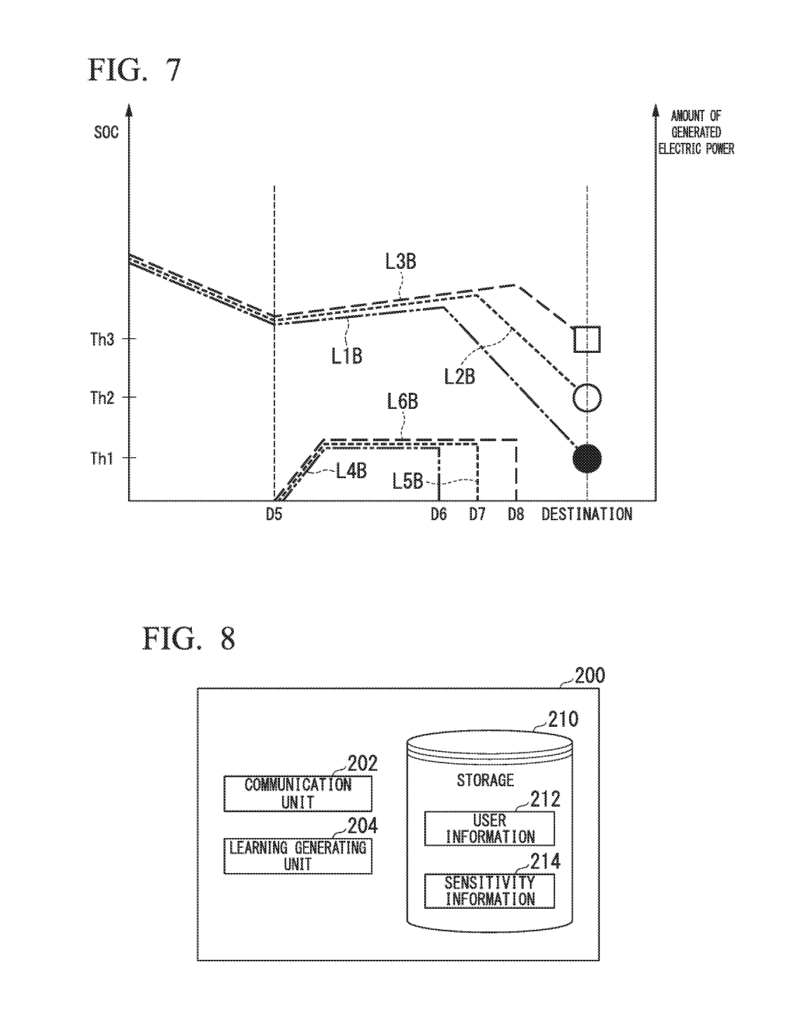

FIG. 7 is a diagram showing another example (2) of the power generation plan. Description similar to that presented with reference to FIG. 5 will not be presented here. Transition lines L1B to L3B respectively represent transitions of SOC of a first power generation plan to a third power generation plan, and transition lines L4B to L6B respectively represent transitions of the amounts of generated electric power of the first power generation plan to the third power generation plan. More specifically, in a case in which the power generator is started at a distance D5, the first planner 107 stops the power generator at a point positioned a distance D6, the second planner 108 stops the power generator at a point positioned a distance D7, and the third planner 109 stops the power generator at a point positioned a distance D8. In order of the distance D6<the distance D7<the distance D8, a distance from a departure point (or the distance D5) is shorter. In other words, in order of the third plan, the second plan, and the first plan, a time in which the power generator is operated is longer.

As described above, since the power generator generates electric power such that the SOC is not below a threshold relating to the sensitivity of a user, the user's anxiety can be alleviated. In other words, the charge ratio can be controlled in accordance with characteristics of a user.

In the examples described above, although a destination has been described as being set, instead of this (or in addition to this), in a case in which a destination is not set, the power generator may be controlled such that the SOC is not below a lower limit threshold of electric power, which is set for a sensitivity index, accumulated in the battery 60. For example, the first planner 107 operates the power generator such that the SOC is not below a first threshold Th1, the second planner 108 operates the power generator such that the SOC is not below a second threshold Th2, and the third planner 109 operates the power generator such that the SOC is not below a third threshold Th3.

The power generation planner 106 may operate the power generator in a case in which the amount of electric power accumulated in the battery 60 is below a reference remaining amount. In such a case, the power generation planner 106 changes the reference remaining amount in accordance with the identification information of a user. More specifically, the first planner 107, the second planner 108, and the third planner 109 operate the power generator in a case in which the SOC is respectively below a first threshold Th1, a second threshold Th2, and a third threshold Th3. In this way, the user's anxiety can be alleviated. In other words, the charge ratio can be controlled in accordance with characteristics of a user.

In the process described above, although the sensitivity specifier 104 specifies the sensitivity of a user by referring to the sensitivity information 124, the sensitivity specifier 104 may transmit identification information of a user to a cloud server apparatus and requests the cloud server apparatus to specify the sensitivity of the user. In such a case, the sensitivity information 124 is stored in a storage device of the cloud server apparatus, and the cloud server apparatus specifies the sensitivity of the user by referring to the sensitivity information in response to the request from the sensitivity specifier 104. The cloud server apparatus transmits the specified sensitivity of the user to the sensitivity specifier 104.

### [Learning]

Hereinafter, a learning device 200 that generates the sensitivity information 214 will be described. FIG. 8 is a diagram showing the functional configuration of the learning device 200. In the following example, the learning device 200 will be described as being disposed separately from the subject vehicle M, the learning device 200 may be mounted in the subject vehicle M.

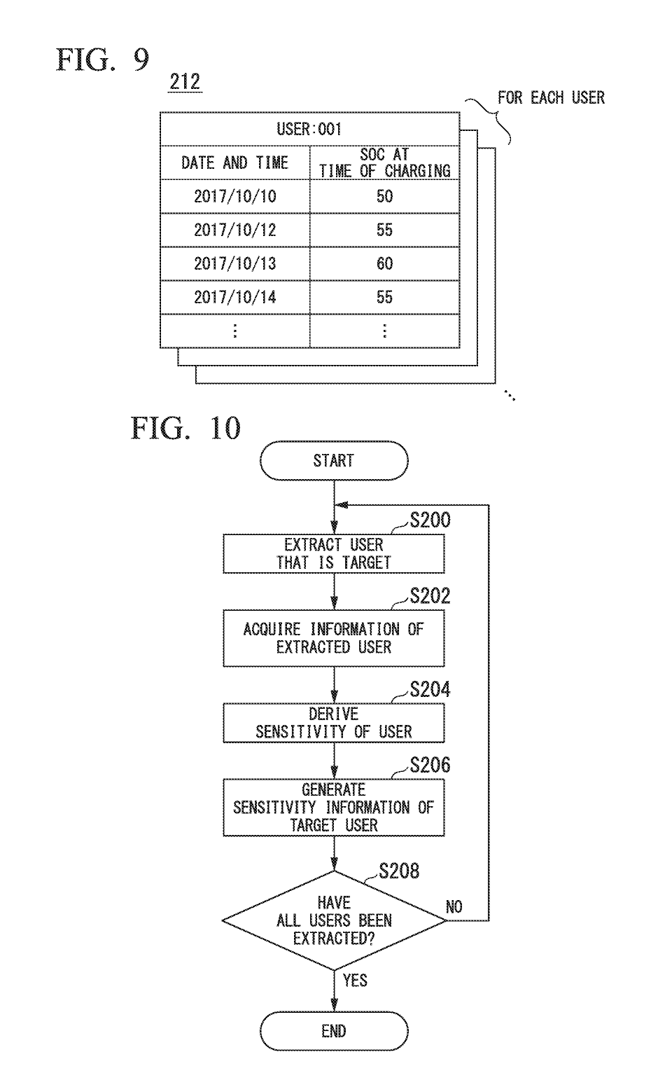

The learning device 200, for example, includes a communication unit 202, a learning generating unit 204, and a storage 210. In the storage 210, for example, user information 212 and sensitivity information 214 (124) are stored. FIG. 9 is a diagram showing an example of the user information 212. The user information 212 is information associating an SOC of a battery 60 in which a user started charging of the battery 60 at a charging spot and a date and time at which the charging of the battery 60 was started with identification information of a user. The user information 212 is information that is acquired by the communication unit 202 from another server apparatus through a network. The user information 212 may be information that is generated by the plan controller 100. In such a case, the plan controller 100 stores the identification information acquired from a captured image and the SOC in which the user started charging the battery 60 in the storage 120 in association with each other.

The sensitivity information 214 is information that is similar to the sensitivity information 124 and is information that is generated by the learning device 200.

The communication unit 202 communicates with another server apparatus, the subject vehicle M, and the like through a network. The learning generating unit 204, for example, generates the sensitivity information 214 by performing machine learning or a statistical process for the user information 212. The learning generating unit 204 may generate the sensitivity information 214 by applying a predetermined algorithm or a predetermined analysis technique. The learning device 200 transmits the generated sensitivity information 214 (124) to the plan controller 100. The plan controller 100 acquires the sensitivity information 214 generated by the learning device 200 and storage the acquired sensitivity information 214 in the storage 210 as the sensitivity information 124.

### [Flowchart]

FIG. 10 is a flowchart showing the flow of a process executed by the learning device 200. First, the learning generating unit 204 extracts a target user by referring to the user information 212 (Step S200) and acquires information of the extracted user (Step S202).

Next, the learning generating unit 204 derives a sensitivity of the user on the basis of the extracted information of the user (Step S204). Next, the learning generating unit 204 generates the sensitivity information 214 of the target user (Step S206). Next, the learning generating unit 204 determines whether or not all the users that are processing targets have been extracted in Step S200 (Step S208). In a case in which all the users have not been extracted, the process is returned to the process of Step S200, and a user of the next target is extracted. On the other hand, in a case in which all the users have been extracted, the process of this flowchart ends.

As described above, the learning generating unit 204 generates the sensitivity information 214 used for specifying a sensitivity of a user. The plan controller 100 can specify a sensitivity of the user on the basis of the sensitivity information 214 generated by the learning generating unit 204.

The first embodiment described above includes the sensitivity specifier 104 that specifies a sensitivity index for identification information of a user acquired by the identification processor 102 on the basis of the relating information associating a sensitivity index representing a sensitivity of anxiety about running out of electric power with the identification information and the controller 110 that sets a period in which the power generator is operated to be longer or sets electric power generated per unit time by the power generator to be more than in a case in which another sensitivity index is specified in a case in which the sensitivity index specified by the sensitivity specifier 104 is higher than the another sensitivity. In this way, the controller 110 controls the power generator such that the SOC is not below a lower limit value of electric power, which is set for the specified sensitivity index specified by the sensitivity specifier 104, accumulated in the battery 60. As a result, the user's anxiety can be alleviated. In other words, the charge ratio can be controlled in accordance with characteristics of a user.

### Second Embodiment

Hereinafter, a second embodiment will be described. In the second embodiment, a vehicle system specifies a sensitivity of a user by referring to a distance to a destination of the user. Hereinafter, points different from the first embodiment will be focused on in the description.

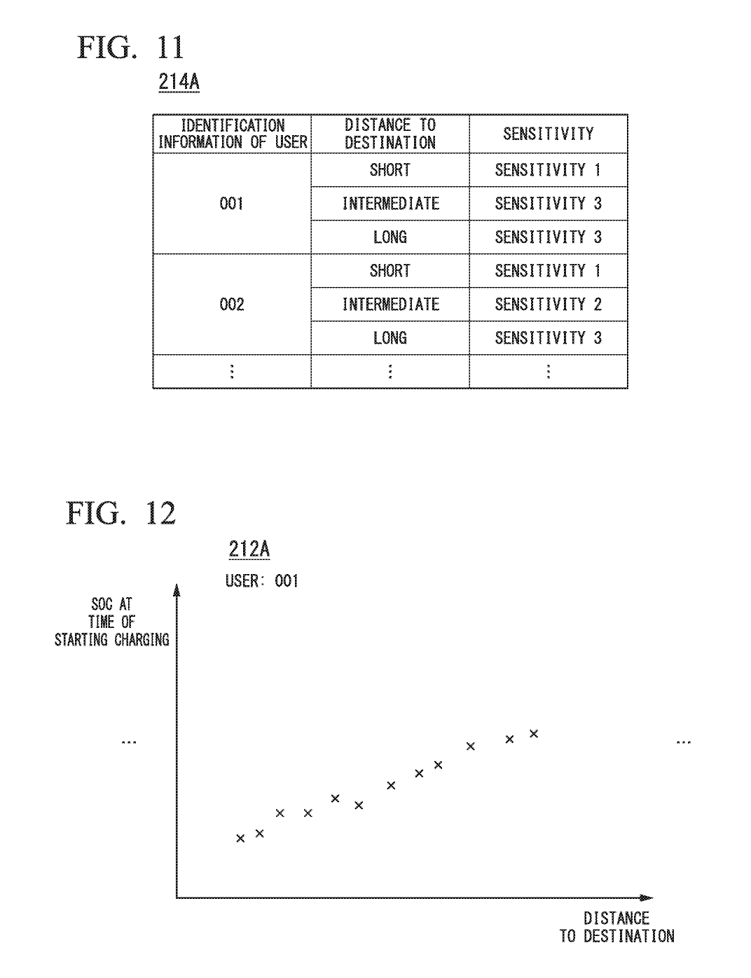

FIG. 11 is a diagram showing an example of sensitivity information 214A used in a second embodiment. The sensitivity information 214A is information associating a distance to a destination and a height of sensitivity with identification information of a user. The sensitivity of a user changes in accordance with a distance to a destination. For example, the sensitivity of a user becomes higher as a distance to the destination is longer.

### [Plan Controller]

The sensitivity specifier 104 acquires a distance to a destination of a user in addition to the identification information of the user. For example, the navigation device derives a distance from a departure place of the subject vehicle M to a destination on the basis of the destination set by the user and outputs the derived distance to the destination to the sensitivity specifier 104. The sensitivity specifier 104 specifies a sensitivity of the user relating to the distance to the destination by referring to the sensitivity information 124A. The power generation planner 106 generates a power generation plan according to a sensitivity of a user relating to the specified distance to the destination.

### [Learning Device]

Hereinafter, a process of a learning generating unit 204 according to the second embodiment will be described. The learning generating unit 204 generates sensitivity information 214A (124A) by referring to the user information 212A. FIG. 12 is a diagram showing an example of the user information 212A. In FIG. 12, the vertical axis represents the SOC when a user starts charging, and the horizontal axis represents a distance to the destination. The example shown in the drawing represents user information 212A of a user “001”, and there is a tendency that charging is started at a higher SOC as the distance to the destination is longer. In other words, as the distance to the destination increases, the user's sensitivity increases.

The learning generating unit 204, for example, generates the sensitivity information 214A by performing machine learning or a statistical process for the user information 212A. The learning generating unit 204 transmits the generated sensitivity information 214A (124A) to the subject vehicle M.

According to the second embodiment described above, on the basis of the sensitivity information 214 associating a sensitivity index having a higher sensitivity of anxiety about running-out of electric power with identification information in a case in which a distance to the destination is long than in a case in which the distance to the destination is short, the sensitivity specifier 104 specifies a sensitivity index having a higher sensitivity of anxiety about running-out of electric power in a case in which a distance to the destination is long than in a case in which the distance to the destination is short, and the controller 110 controls the power generation unit such that the SOC is not below a lower limit threshold of electric power, which is set for the specified sensitivity index, accumulated in the storage battery. As a result, the user's anxiety can be alleviated. In other words, the charge ratio can be controlled in accordance with the characteristics of a user.

The learning device 200 may generate sensitivity information 214 by performing learning of information associating predetermined information with an SOC when charging is started. Here, the predetermined information is information of some or all of a destination, a route, a season, a date and time, and a set temperature of an air conditioner. In such a case, the sensitivity specifier 104 specifies a sensitivity of the user on the basis of the predetermined information described above by referring to the sensitivity information 214. By using the process described above, a sensitivity of the user according to use environments and a use status can be specified. As a result, the user's anxiety can be further alleviated.

In generating the sensitivity information 214, the learning device 200 may use information representing a user state that is actually acquired (hereinafter, referred to as user state information). Here, the user state information is a result acquired by analyzing a user's facial expression captured by the camera, information acquired using a biological sensor that is mounted in a user and acquires a pulse rate, a heart rate, or the like, and the like. Instead of (or in addition to) the SOC (initial SOC) when charging is started, the learning device 200 generates sensitivity information 214 using the information representing the user state.

For example, the learning generating unit 204 derives a score for a combination of the initial SOC and the user state information and determines that the higher a user's sensitivity the higher the score. The learning generating unit 204, for example, may extract an initial SOC when the sensitivity represented in the user state information is a predetermined degree or more, perform machine learning of learning data including the extracted initial SOC and the sensitivity of the user for the initial SOC, and generate the sensitivity information 214. In other words, the learning generating unit 204, for example, performs machine learning of the SOC in which charging is started in a state in which user's anxiety is a predetermined degree or more and generates the sensitivity information 214. Accordingly, a model and the like used for specifying the sensitivity of the user is generated on the basis of identification information for identifying the user.

According to the embodiment described above, by including the power generator including the engine 10 that outputs power and the first motor 12 that generates electric power using the power output by the engine 10, the identification processor 102 acquiring identification information for identifying a user, and the controller 110 adjusting a period in which the power generator is operated or an electric power per unit time generated by the power generator in accordance with the identification information acquired by the identification processor 102, the charge ratio can be controlled in accordance with the characteristics of a user.

### [Hardware Configuration]

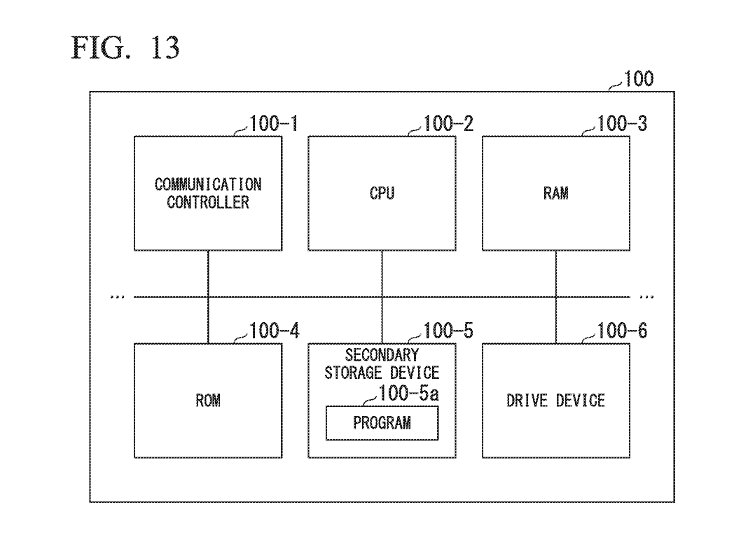

The plan controller 100 of the vehicle system 1 according to the embodiment described above, for example, is implemented by the hardware configuration as shown in FIG. 13. FIG. 13 is a diagram showing an example of the hardware configuration of a controller (plan controller 100) according to an embodiment.

The controller has a configuration in which a communication controller 100-1, a CPU 100-2, a RAM 100-3, a ROM 100-4, a secondary storage device 100-5 such as a flash memory or an HDD, and a drive device 100-6 are interconnected through an internal bus or a dedicated communication line. In the drive device 100-6, a portable storage medium such as an optical disc is loaded. A program 100-5a stored in the secondary storage device 100-5 is stored into the RAM 100-3 using a DMA controller (not shown in the drawing) or the like and is executed by the CPU 100-2, whereby the controller is implemented. The program referred to by the CPU 100-2 may be stored in a portable storage medium loaded in the drive device 100-6 or may be downloaded from another device through a network NW.

The embodiment described above can be represented as below.

A vehicle control system including: a power generator including an internal combustion engine that outputs power and a power generator that generates electric power using the power output by the internal combustion engine; a storage device; and a hardware processor executing a program stored in the storage device, acquires identification information for identifying a user, and adjusts a period in which the power generator is operated or an electric power per unit time generated by the power generator in accordance with the acquired identification information.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control system comprising:
a power generator including an internal combustion engine is configured to output power and a generator is configured to generate electric power using the power output by the internal combustion engine;
an information acquirer is configured to acquire identification information for identifying a user; and
a controller is configured to adjust a period in which the power generator is operated or an electric power per unit time generated by the power generator in accordance with the identification information acquired by the information acquirer.

2. The vehicle control system according to claim 1, further comprising a specifier is configured to specify an index of the user by referring to relating information associating the index with the identification information using the identification information of the user acquired by the information acquirer,
wherein the controller is configured to adjust the period in which the power generator is operated or the electric power per unit time generated by the power generator on the basis of the index specified by the specifier.

3. The vehicle control system according to claim 2, wherein, in a case in which a first index specified by the specifier is specified among a plurality of indexes including at least the first index and a second index representing a lower sensitivity than that of the first index, the controller is configured to perform at least one or more control operations among controlling the period in which the power generator is operated such that it becomes longer, controlling the electric power per unit time generated by the power generator to be higher, controlling a timing at which the power generator is operated to be earlier, and controlling a timing at which the power generator is stopped after operating the power generator to be later than in a case in which the second index is specified.

4. The vehicle control system according to claim 1, further comprising:
a storage battery is configured to accumulate electric power generated by the power generator; and
an electric motor for driving connected to driving wheels of a vehicle and rotating the driving wheels by performing driving using electric power supplied from the power generator or the storage battery,
wherein the power of the internal combustion engine is used only by the generator.

5. The vehicle control system according to claim 1, further comprising:
a specifier is configured to specify an index of the user by referring to relating information associating the index with the identification information using the identification information of the user acquired by the information acquirer,
wherein the controller controls the power generator such that generated electric power is not below a lower limit threshold of electric power, which is set for the index specified by the specifier, accumulated in the storage battery is configured to accumulate the electric power generated by the power generator.

6. The vehicle control system according to claim 1, further comprising:
a specifier is configured to specify an index relating to the identification information of the user and a distance to a destination acquired by the information acquirer by referring to relating information associating the index and the distance to the destination with the identification information,
wherein the information acquirer is configured to acquire the distance to the destination relating to the acquired identification information.

7. The vehicle control system according to claim 6,
wherein, in the relating information, in a case in which the distance to the destination is long, a higher index is associated with the identification information than in a case in which the distance to the destination is short, and
wherein, in a case in which the distance to the destination is long, the specifier specifies a higher index than in a case in which the distance to the destination is short.

8. The vehicle control system according to claim 1, further comprising a storage battery is configured to accumulate the electric power generated by the generator, and an electric motor for driving connected to driving wheels of a vehicle and rotating the driving wheels by being driven using electric power supplied from the power generator or the storage battery;
wherein the power of the internal combustion engine being used only by the power generator,
wherein the controller is configured to change the reference remaining amount in accordance with the identification information acquired by the information acquirer and operate the power generator in a case in which an amount of electric power accumulated in the storage battery is below a reference remaining amount.

9. A vehicle control method using an in-vehicle computer, the vehicle control method comprising:
acquiring identification information for identifying a user; and
adjusting a period in which a power generator including an internal combustion engine is configured to output power and a power generator is configured to generate electric power using the power output by the internal combustion engine is operated or an electric power per unit time generated by the power generator in accordance with the acquired identification information.

10. A non-transitory computer-readable storage medium that stores a computer program to be executed by a computer to perform at least:
acquire identification information for identifying a user; and
adjust a period in which a power generator including an internal combustion engine is configured to output power and a power generator is configured to generate electric power using the power output by the internal combustion engine is operated or an electric power per unit time generated by the power generator in accordance with the acquired identification information.
